(19) United States
(12) Patent Application Publication
(10) Pub. No.: US 2026/0199835 A1
(43) Pub. Date: Jul. 16, 2026

(54) METHOD FOR OPERATING A DRIVE DEVICE AND CORRESPONDING DRIVE DEVICE

(71) Applicant: AUDI Aktiengesellschaft, Ingolstadt (DE)

(72) Inventors: Faruk CAN, Neudenau (DE); Alexey SMIRNOV, Stuttgart (DE)

(73) Assignee: AUDI Aktiengesellschaft, Ingolstadt (DE)

(21) Appl. No.: 19/135,912

(22) PCT Filed: Dec. 1, 2023
(86) PCT No.: PCT/EP2023/083973

§ 371 Date: Jun. 5, 2025

(30) Foreign Application Priority Data
Dec. 9, 2022 (DE) 102022213338.2

(51) Int. Cl. B01D 53/94; F01N 3/20

(52) U.S. Cl. CPC B01D 53/9418; B01D 53/9495; F01N 3/2066; F01N 3/208; B01D 2251/2067; B01D 2257/404; B01D 2258/01; F01N 2900/1402; F01N 2900/16; F01N 2900/1818

(57) ABSTRACT

A method for operating a drive device which has an exhaust gas-generating drive unit and at least one vehicle SCR catalytic converter for aftertreatment of the exhaust gas. A reducing agent is added to the exhaust gas at least temporarily upstream of the vehicle catalytic converter. A first nitrogen oxide value describing the nitrogen oxide content of the exhaust gas upstream of the vehicle catalytic converter and a second nitrogen oxide value describing the nitrogen oxide content of the exhaust gas downstream of the vehicle catalytic converter are determined and, at least temporarily, a first slip indicator is determined using a first reducing agent slip model and a second slip indicator is determined using a second reducing agent slip model on the basis of the nitrogen oxide values. A total slip indicator is determined from the first slip indicator and the second slip indicator.

### FIELD

The invention relates to a method for operating a drive device, in particular for a motor vehicle, which has an exhaust gas-generating drive unit and at least one vehicle catalytic converter configured as an SCR catalytic converter for aftertreatment of the exhaust gas, wherein a reducing agent is added to the exhaust gas at least temporarily upstream of the vehicle catalytic converter. The invention also relates to a drive device, in particular for a motor vehicle.

### BACKGROUND

Publication DE 10 2005 031 720 B4, for example, is known from the state of the art. This describes a method for dosing a reducing agent configured as an aqueous urea solution into an exhaust gas line of an internal combustion engine with an exhaust gas purification system, comprising a valve arranged in the exhaust gas line for adding the reducing agent to the exhaust gas and a nitrogen oxide reduction catalytic converter arranged downstream of the dosing valve in the exhaust gas line, configured as an SCR catalytic converter, at which a selective reduction of nitrogen oxides contained in the exhaust gas with ammonia can take place, and a control device for controlling the exhaust gas purification system, wherein the control device sets a dosing rate of reducing agent to be added to the exhaust gas via the dosing valve.

It is provided that the control device determines changes in a wall film mass of reducing agent deposited on the inner wall of the exhaust gas line and takes them into account when setting the dosing rate, wherein the control device determines an accumulation rate of reducing agent deposited in the wall film and a desorption rate of reducing agent desorbing from the wall film and the amount of wall film mass is continuously determined by balancing the accumulation rate and the desorption rate. Furthermore, the publication DE 10 2009 034 622 B4 discloses a dosing control system and a dosing control method with continuous storage estimation for catalysts for selective catalytic reduction.

The objective of the invention is to propose a method for operating a drive direction, in particular for a motor vehicle, which comprises advantages over known methods, in particular reliably detects and indicates a breaking through of the reducing agent through the vehicle catalytic converter with low latency.

### SUMMARY

According to the invention, this is achieved with a method for operating a drive device, in particular for a motor vehicle. It is provided that, in particular by means of a first nitrogen oxide sensor, a first nitrogen oxide value describing the nitrogen oxide content of the exhaust gas upstream of the vehicle catalytic converter and, in particular by means of a second nitrogen oxide sensor, a second nitrogen oxide value describing the nitrogen oxide content of the exhaust gas downstream of the vehicle catalytic converter is determined and, at least temporarily, a first slip indicator is determined using a first reducing agent slip model and a second slip indicator is determined using a second reducing agent slip model on the basis of the nitrogen oxide values, wherein an overall slip indicator is determined from the first slip indicator and the second slip indicator.

This is done by setting the total slip indicator to a second status, corresponding to reducing agent slip, for a certain period of time, if one of the slip indicators changes status from a first status, corresponding to the absence of reducing agent slip, to a second status, corresponding to reducing agent slip, and resetting it to the first status, if the other of the slip indicators has not changed status by the end of the first period of time, and/or, if the status of one of the slip indicators changes from the second status to the first status while the other of the slip indicators persists, by setting the total slip indicator to the first value only after a specific second period of time has elapsed and if the status of the respective other of the slip indicators changes before the second period of time has elapsed.

It should be noted that the exemplary embodiments explained in the description are not limiting; rather, any variations of the features disclosed in the description, the claims and the figures can be realized.

The drive device is preferably used to drive the motor vehicle, that is to provide a drive torque directed towards driving the motor vehicle. To provide the drive torque, the drive unit comprises the drive direction. Fuel and fresh gas are supplied to the drive unit at least temporarily during operation of the drive device, wherein the fresh gas contains fresh air at least temporarily. In addition, the fresh gas may comprise exhaust gas, provided that exhaust gas recirculation is implemented, in which the exhaust gas generated by the drive unit is at least partially returned to the drive unit, namely as a component of the fresh gas. The fuel and the fresh gas supplied to the drive unit form a fuel/fresh gas mixture with a specific composition, which is reacted in the drive unit.

During operation of the drive unit, the chemical reaction of fuel and fresh gas together produces exhaust gas, which is discharged towards an outer environment of the drive unit or motor vehicle. As the exhaust gas produced by the drive unit contains pollutants, in particular nitrogen oxides, the exhaust gas is first fed to an exhaust gas aftertreatment device before being discharged into the outer environment. In the exhaust gas aftertreatment device, the pollutants are at least partially converted into less harmful products. Only after passing through the exhaust gas aftertreatment device is the exhaust gas discharged into the outer environment.

The exhaust gas aftertreatment device comprises at least one vehicle catalytic converter, which is configured as an SCR catalytic converter. The SCR catalytic converter is provided and configured to carry out a selective catalytic reduction of pollutants, in particular nitrogen oxides. To carry out the reduction, the reducing agent is added to the exhaust gas, namely upstream of the vehicle catalytic converter or—in other words—between the drive unit and the vehicle catalytic converter, preferably between the first nitrogen oxide sensor—if present—and the vehicle catalytic converter. This means that the reducing agent passes through the vehicle catalytic converter together with the exhaust gas and causes or at least promotes the reduction of the pollutants in the exhaust gas. Ammonia, for example, is used as a reducing agent, which is preferably introduced into the exhaust gas in the form of an aqueous urea solution. The ammonia is produced from the urea solution by thermolysis in the exhaust gas.

In addition to the SCR catalytic converter, the exhaust gas aftertreatment device can have at least one further vehicle catalytic converter and/or a particulate filter. The further vehicle catalytic converter is present, for example, as a three-way catalytic converter, oxidation catalytic converter, NOx-storage catalytic converter or the like. The particulate filter is preferably configured as a petrol particulate filter or a diesel particulate filter. The particulate filter can be manufactured with an integrated vehicle catalytic converter and comprise a catalytic coating, for example.

A certain amount of reducing agent is required to convert the pollutants into the less harmful products in the vehicle catalytic converter. Excess reducing agent passes through the vehicle catalytic converter at least partially chemically unchanged or is desorbed from the vehicle catalytic converter. This is as reducing agent slip and leads to a deterioration in vehicle emissions. There are already concepts for detecting reducing agent slip and for adjusting the amount of reducing agent introduced into the exhaust gas or the reducing agent flow rate. However, these are not sufficiently accurate and/or only provide the required information with a time delay.

The latter also applies to a measurement of the reducing agent concentration downstream of the vehicle catalytic converter. As soon as the measured reducing agent concentration exceeds a corresponding threshold value, an impermissibly large amount of reducing agent is already entering the outer environment. This means that a reaction to the exceeding of the threshold value only takes place when the reducing agent has already passed through the vehicle catalytic converter. However, the aim is to detect the slip of the reducing agent before or as soon as it actually occurs and to initiate appropriate countermeasures. These consist, for example, of adjusting the quantity of reducing agent introduced or the mass flow of reducing agent.

To detect reductant slip or imminent reductant slip, the nitrogen oxide content of the exhaust gas is first determined, on the one hand upstream of the vehicle catalytic converter and on the other hand downstream of the vehicle catalytic converter. For this purpose, for example, the first nitrogen oxide value is measured using the first nitrogen oxide sensor and the second nitrogen oxide value is measured using the second nitrogen oxide sensor. Alternatively, the first nitrogen oxide value can be determined using a model. In this case, the first nitrogen oxide sensor can be omitted and the second nitrogen oxide sensor can simply be referred to as the nitrogen oxide sensor.

The first nitrogen oxide value describes the nitrogen oxide content of the exhaust gas upstream of the vehicle catalytic converter and the second nitrogen oxide value describes the nitrogen oxide content of the exhaust gas downstream of the vehicle catalytic converter. In other words, the first nitrogen oxide value is determined by the flow between the drive unit and the vehicle catalytic converter and the second nitrogen oxide value is determined by the flow between the vehicle catalytic converter and a tailpipe through which the exhaust gas from the drive device is released into the outer environment.

The nitrogen oxide sensor or the nitrogen oxide sensors react not only to nitrogen oxide but also cross-sensitively to the reducing agent. In this respect, the first nitrogen oxide content and the second nitrogen oxide content do not correspond, at least temporarily, to the actual nitrogen oxide content of the exhaust gas at the respective point, but are falsified by the reducing agent content of the exhaust gas. Therefore, the nitrogen oxide sensors or the nitrogen oxide values can be used to assess the reducing agent penetration.

Slip indicators are determined on the basis of the two nitrogen oxide values, namely using two different reducing agent slip models. The slip indicators are status indicators that indicate whether the respective reducing agent slip model detects reducing agent slip or not. If the respective slip indicator comprises a first value, the respective reducing agent slippage model assumes that there is no reducing agent slippage. With the second status, however, the respective reducing agent slip model assumes the presence of reducing agent slip. In total, two slip indicators are therefore determined on the basis of the two nitrogen oxide values, namely the first slip indicator and the second slip indicator. This is done using different reducing agent slip models, namely the first reducing agent slip model and the second reducing agent slip model. The slip indicators comprise either the first value or the second value, intermediate values are not provided.

By using the two different reducing agent slip models, redundancy is achieved and the quality of the statement is improved. However, the two reducing agent slip models determine the respective slip indicator independently of each other, so that an evaluation of the slip indicators is subsequently necessary in order to determine whether the reducing agent slip is actually present or not. This should be as robust as possible and enable a reliable assessment of whether reducing agent slip is present.

During the evaluation, the total slip indicator is determined, which ultimately indicates whether the reducing agent slip is present or not. In this respect, the total slip indicator can also assume the first status and the second status, in particular only the first status and the second status. This means that the first slip indicator, the second slip indicator and the total slip indicator each correspond to the first status at times and to the second status at times.

In order to determine the total slip indicator from the two slip indicators, the total slip indicator is initially set to the second status when the status of the slip indicator changes from the first status to the second status, namely at least over the first time period. In the case of the first status, reducing agent slip is not detected, that is according to the models, there is no reducing agent slip. In the case of the second status, however, reducing agent slip is detected. If the status of the other slip indicator does not change by the end of the first time period, the overall slip indicator is reset to the first status. If, on the other hand, the other slip indicator also changes to the second status, the total slip indicator remains in the second status and is therefore not reset.

On the one hand, this procedure ensures high sensitivity when detecting reducing agent slip. On the other hand, however, false detection of reducing agent slip is prevented by assuming that both slip indicators must comprise the second status after the first time period has elapsed so that the overall slip indicator also continues to display the second status and thus reducing agent slip. The first time period is, for example, at least 0.1 s, at least 0.5 s or at least 1 s.

Additionally or alternatively, it is provided that when the status of the slip indicator changes from the second status to the first status and while the other slip indicator remains in the second status at the same time, the total slip indicator is not set to the first value until after the second time period has elapsed. However, if the other slip indicator also changes from the second status to the first status, in particular before the second time period has elapsed, the total slip indicator is immediately set to the first value, that is before the second time period has elapsed. The second time period can correspond to the first time period.

The total slip indicator is summarized from the second value to the first value as soon as at least one of two conditions is met. According to the first condition, the status change from the second status to the first status is present for the slip indicator, whereas the other slip indicator remains in the second status, but the second time period has already elapsed since the status change of the slip indicator. According to the second condition, the status change from the second status to the first status is present for both the first slip indicator and the second slip indicator. In this case, the total slip indicator is set from the second value to the first value independent of the second time period.

The procedure described ensures reliable detection of the reducing agent slip, as the total slip indicator does not depend on just one reducing agent slip model, but two reducing agent slip models are included in it, and in particular a simple OR link between the two slip indicators is not carried out.

An embodiment of the invention provides that the first reductant slip model comprises a frequency model and/or a correlation model, wherein a frequency model concentration value is determined for the frequency model by means of a frequency analysis of the nitrogen oxide values, in particular using at least one recursive filter, and a first partial indicator is set to the first value, if the frequency model concentration value falls below a first frequency model threshold value, and is set to the second value, if the frequency model concentration value exceeds a second frequency model threshold value, and/or wherein a correlation coefficient is determined from the nitrogen oxide values for the correlation model, wherein a second partial indicator is set to the first value, if a distance of the correlation coefficient from a setpoint value, which corresponds to a match of the nitrogen oxide values, falls below a first correlation model threshold value, and is set to the second value, if the distance of the correlation coefficient from the setpoint value exceeds a second correlation model threshold value, and/or wherein the first slip indicator is set to the second value, if the first partial indicator corresponds to the second value and/or the second partial indicator corresponds to the second value and is set to the first value, if the first partial indicator corresponds to the first value and/or the second partial indicator corresponds to the first value.

The first reducing agent slip model therefore contains at least one sub-model or several sub-models, namely the frequency model and the correlation model. The frequency analysis of the nitrogen oxide values is carried out for the frequency model. The frequency analysis is implemented, for example, as a Fourier analysis, in particular using a discrete Fourier transform or a Fast Fourier transform (FFT). Preferably, the recursive filter is also used, i.e. a filter whose output values are also used as input values. In other words, an output of the recursive filter is connected to an input of the recursive filter. The recursive filter comprises certain filter parameters.

As part of the frequency analysis, the frequency model concentration value is determined, which describes a reducing agent concentration downstream of the vehicle catalytic converter. In particular, the frequency model concentration value is determined from the low-pass-filtered first nitrogen oxide value, the low-pass-filtered second nitrogen oxide value, the high-pass-filtered first nitrogen oxide value and the high-pass-filtered second nitrogen oxide value. Preferably, the relationship

$${k}_{NH 3} = TP ( NOxDS ) - \frac{HP ( NOxDS )}{HP ( NOxUS )} \cdot TP ( NOxUS )$$

is used. TP stands for low-pass filtering, HP for high-pass filtering; NOxUS is the first nitrogen oxide value, NOxDS the second nitrogen oxide value. Values of the respective measured value that are temporarily stored in a buffer memory are preferably used for filtering.

The low-pass filtered first nitrogen oxide value describes both the reducing agent concentration and the nitrogen oxide concentration downstream of the vehicle catalytic converter. The ratio of the high-pass filtered second nitrogen oxide value and the high-pass filtered first nitrogen oxide value corresponds to a conversion ratio for the nitrogen oxide in the vehicle catalytic converter. The low-pass filtered first nitrogen oxide value in turn describes the nitrogen oxide concentration of the exhaust gas upstream of the vehicle catalytic converter. The term

$$\frac{HP ( NOxDS )}{HP ( NOxUS )} \cdot TP ( NOxUS )$$

therefore describes the nitrogen oxide concentration downstream of the vehicle catalytic converter. The nitrogen oxide concentration calculated using this term is also referred to as the model nitrogen oxide concentration; the term itself is used as part of a nitrogen oxide concentration model.

If the frequency model concentration value is smaller than the first frequency model threshold value, the first partial indicator is set to the first value. If, on the other hand, the frequency model concentration value is greater than the second frequency model threshold value, the first partial indicator is set to the second value. The first frequency model threshold value and the second frequency model threshold value can be identical. Preferably, however, they are different from each other to achieve a hysteresis-like behaviour of the frequency model.

As part of the correlation model, the correlation coefficient is determined, which describes the degree of agreement between the nitrogen oxide values. The correlation coefficient is, for example, the empirical correlation coefficient, for the determination of which the relationship

$${r}_{x , y} = \frac{{\sum }_{i = 1}^{n} ( {x}_{i} - \overline{x} ) ( {y}_{i} - \overline{y} )}{\sqrt{{\sum }_{i = 1}^{n} {( {x}_{i} - \overline{x} )}^{2} {( {y}_{i} - \overline{y} )}^{2}}}$$

is used. Here, x is the first nitrogen oxide value and y is the second nitrogen oxide value. The correlation coefficient is determined using the values temporarily stored in the buffer memory or buffer memories.

There is preferably a separate buffer memory for each of the nitrogen oxide values, that is a first buffer memory for the first nitrogen oxide value and a second buffer memory for the second nitrogen oxide value. The last values of the nitrogen oxide values are preferably stored in the buffer memories in the manner of a FIFO buffer memory. The size n denotes the number of values from the buffer memory for which the calculation is performed. It can correspond at most to the number of values stored in the buffer memory. The index i is the specific value from the buffer memory that is used for the calculation.

The average values are calculated using the nitrogen oxide values temporarily stored in the buffer memory. Preferably

$$\overline{x} = \frac{1}{n} {\sum }_{i = 1}^{n} {x}_{i} and \overline{y} = \frac{1}{n} {\sum }_{i = 1}^{n} {y}_{i}$$

when determining the mean values, wherein again the values of the nitrogen oxide values temporarily stored in the buffer memories are used.

If the correlation coefficient r_{x,y} approaches 1, there is a high probability that there is no reducing agent slip. However, if it approaches 0, there is probably reducing agent slip. Accordingly, the distance between the correlation coefficient and the setpoint value is checked as part of the correlation model. In particular, the setpoint value is equal to 1. If the distance of the correlation coefficient from the setpoint value is smaller than the first correlation model threshold value, the second partial indicator is set to the first value. If, on the other hand, it is greater than the second correlation model threshold, the second partial indicator is set to the second value. The first correlation model threshold value and the second correlation model threshold value can again be identical. Preferably, however, they are different from each other to achieve hysteresis-like behaviour.

It may be provided that the first reducing agent slip model only contains the frequency model or the correlation model. In this case, the first slip indicator is set equal to the first partial indicator or the second partial indicator. If, on the other hand, both the frequency model and the correlation model are used, both partial indicators are included in the first slip indicator and are linked to each other accordingly. Preferably, the first slip indicator is already set to the second value if only one of the two partial indicators comprises the second value. Conversely, the first slip indicator is only set to the first value as soon as both partial indicators comprise the first value. However, it may also be provided that the first slip indicator is not set to the second value until both partial indicators comprise the second value. In this case, the first slip indicator is already set to the first value if only one of the two partial indicators comprises this value.

Using the frequency model, the correlation model or both the frequency model and the correlation model and linking their results enables a particularly good prediction quality to be achieved. Accordingly, the accuracy of the first slip indicator is high.

An embodiment of the invention provides that the first slip indicator is set to the second value even if a second nitrogen oxide concentration determined from the second nitrogen oxide value is greater than a first nitrogen oxide concentration determined from the first nitrogen oxide value and the second nitrogen oxide concentration is greater than a model nitrogen oxide concentration calculated from the first nitrogen oxide value and the second nitrogen oxide value on the basis of a nitrogen oxide concentration model, and/or if the second nitrogen oxide concentration is greater than the first nitrogen oxide concentration during a thrust operation of the drive device.

The first slip indicator therefore depends on variables other than the first reducing agent slip model or in the frequency model and/or the correlation model. First, the nitrogen oxide concentrations are determined from the two nitrogen oxide values, namely directly from the nitrogen oxide values and without any consideration of cross-influences from any reducing agents contained in the exhaust gas. Furthermore, the model nitrogen oxide concentration is calculated from the nitrogen oxide value, namely according to the previous explanations. If both the second nitrogen oxide concentration is greater than the first nitrogen oxide concentration and the second nitrogen oxide concentration is greater than the model nitrogen oxide concentration, it is assumed that the second nitrogen oxide value is influenced by reducing agent present downstream of the vehicle catalytic converter and that there is therefore reducing agent slip.

In addition or alternatively, the first slip indicator is also set to the second value if, on the one hand, the thrust mode of the drive device is detected and, at the same time, the second nitrogen oxide concentration is greater than the first nitrogen oxide concentration. The thrust mode is to be understood such that the drive device or drive unit is being towed, that is driven by the kinetic energy of the motor vehicle. This means that the drive device or drive unit provides no drive torque or only a low drive torque.

For example, thrust mode is detected by determining, in particular measuring, an oxygen concentration in the exhaust gas upstream of the vehicle catalytic converter. If the oxygen concentration is above a first oxygen concentration threshold value, thrust mode is detected; if it is lower than a second oxygen concentration threshold value, thrust mode is not detected. The two oxygen concentration threshold values can in turn be identical, but are preferably different from each other to achieve hysteresis-like behaviour. The additional influencing of the first slip indicator by one or both of the above conditions further improves the quality of detection for reductant slip.

An embodiment of the invention provides that, while the first slip indicator corresponds to the second value, a first reducing agent mass flow is determined from at least one of the nitrogen oxide values and at least one state variable of the drive device, in particular an exhaust gas temperature, by means of a reducing agent mass flow model. If the first slip indicator comprises the second value, it can be assumed that reducing agent slip is present. In this case, the reducing agent mass flow rate should also be determined in order to establish the extent of the reducing agent slip. This is done using the reducing agent mass flow model, which comprises at least one of the nitrogen oxide values and the at least one state variable of the drive device as input variables and the reducing agent mass flow as output variable.

For example, an intermediate value is calculated using the second measured value and the state variable, preferably using a mathematical relationship, a map or a table. The exhaust gas temperature is preferably used as the state variable at. It may be provided that the reducing agent mass flow is set equal to the intermediate value. However, it is particularly preferred that the intermediate value is multiplied beforehand by a factor resulting from a subtraction of the model nitrogen oxide concentration from the second nitrogen oxide concentration. In other words, the factor is equal to the second nitrogen oxide concentration minus the model nitrogen oxide concentration. The procedure described enables the reducing agent mass flow rate to be determined with a high degree of accuracy.

An embodiment of the invention provides that in the second reducing agent slip model at least one of the nitrogen oxide values and at least one state variable of the drive device are used as input variables of a characteristic map, in particular filtered by means of a further recursive filter, from which a second reducing agent mass flow results as an output variable, wherein the second slip indicator is set to the first value, if the second reducing agent mass flow falls below a first reducing agent slip model threshold value, and is set to the second value, if the second reducing agent mass flow exceeds a second reducing agent slip model threshold value.

In this respect, the second reducing agent slip model is map-based. The first nitrogen oxide value, the second nitrogen oxide value or both nitrogen oxide values and the at least one state variable serve as input variables for the characteristic map. The characteristic map is used to determine the output variable, namely the second reducing agent mass flow, from the input variables. If the second reducing agent mass flow is less than the first reducing agent slip model threshold value, the second slip indicator is set to the first value. If, on the other hand, the second reducing agent mass flow rate is greater than the second value, the second slip indicator is set to the second value. The first reducing agent slip model threshold value and the second reducing agent slip model threshold value can be identical. Preferably, however, they are different from each other to achieve hysteresis-like behaviour.

Preferably, both the first nitrogen oxide value and the second nitrogen oxide value are used as input variables for the characteristic map, wherein the first nitrogen oxide value is used directly and the second nitrogen oxide value is used in the form of a difference between the second nitrogen oxide value and the model nitrogen oxide concentration. In other words, the input variables are formed at least from the first nitrogen oxide value and the difference between the second nitrogen oxide value minus the model nitrogen oxide concentration. In addition to the at least one nitrogen oxide value, the at least one state variable is used as an input variable. The state variable is in particular a temperature, preferably an exhaust gas temperature. Furthermore, a temperature gradient, in particular a time gradient of the exhaust gas temperature, can be used as an input variable. Additionally or alternatively, the exhaust gas mass flow is used as an input variable. It is particularly preferred that at least one of the input variables is subjected to low-pass filtering, in particular recursive low-pass filtering. The filter parameters of the filtering preferably correspond to the filter parameters already mentioned above.

Such a method is known, for example, from the disclosure document DE 10 2020 111 204 A1, the disclosure document DE 10 2020 111 206 A1 and the disclosure document DE 10 2020 111 208 A1, the disclosure of which is fully incorporated into the present description by reference. Disclosure DE 10 2020 111 204 A1 describes a method for operating a control device for a motor vehicle, wherein n-dimensional reference input vectors are each assigned a reference output vector, from which an output vector is determined for an n-dimensional input vector, wherein the following steps are carried out:
a. Repeat the following steps until there is a reference input vector in an n-dimensional space around the input vector whose distance to the input vector falls below a threshold value and/or a maximum number of iterations is reached:
   i. Select at least one neighbour vector from the reference input vectors,
   ii. Determining an additional reference input vector from the at least one neighbour vector and adding the additional reference input vector to the reference input vectors;
b. Selecting at least one calculation vector closest to the input vector from the reference input vectors and calculating the output vector using the at least one selected calculation vector.

The n-dimensional reference input vectors and the reference output vectors define the characteristic map or are stored in the characteristic map. The n-dimensional input vector is defined by the input variables, wherein each of the input variables represents one dimension of the input vector. In the case of the procedure described above, there is therefore a five-dimensional input vector that contains the first nitrogen oxide value, the temperature, the temperature gradient, the exhaust gas mass flow and the difference between the second nitrogen oxide value and the model nitrogen oxide concentration. The output vector contains the second reducing agent mass flow, so that the output vector is one-dimensional in this case.

The control device of DE 10 2020 111 204 A1 is a component of the drive device and is used in particular to control the drive device or the drive unit. At the very least, it determines the second reducing agent mass flow during operation of the drive device. Particularly preferably, the control device also performs the first reducing agent slip model and determines the total slip indicator from the two slip indicators.

When determining the second reducing agent slip model threshold value, the procedure is preferably carried out according to claim 1 of the disclosure DE 10 2020 111 204 A1, namely according to the definitions already mentioned. The procedure may be further embodied according to one or more of claims 2 to 10 of DE 10 2020 111 204 A1. Further advantageous embodiments of the procedure can be found in the description of the disclosure DE 10 2020 111 204 A1, which is incorporated by reference in its entirety. The procedure described enables a particularly accurate determination of the reducing agent mass flow and thus of the second slip indicator.

An embodiment of the invention provides that a reducing agent concentration present downstream of the vehicle catalytic converter is measured by means of a reducing agent sensor and used to adapt the characteristic map. The reducing agent sensor is purely optional. If present, it is used to measure the reducing agent concentration downstream of the vehicle catalytic converter and thus to check the reducing agent slip models. It is particularly advantageous for adapting the characteristic map of the second reducing agent slip model in order to improve its accuracy during operation of the drive device. The corresponding reducing agent mass flow rate is preferably determined from the reducing agent concentration, in particular using the exhaust gas mass flow rate.

The reducing agent mass flow resulting from the reducing agent concentration is compared with the second reducing agent mass flow. If it deviates, in particular by more than a permissible tolerance, the reducing agent mass flow determined from the reducing agent concentration and the associated input variables are included in the characteristic map. This is particularly preferably done in accordance with the procedure explained in the disclosure document DE 10 2020 111 206 A1. This describes a method for operating a control device for a motor vehicle, wherein n-dimensional reference input vectors are each assigned a reference output vector, from which an output vector can be determined at least for an n-dimensional input vector, and wherein the following steps are carried out when a new reference input vector with associated new reference output vector is present:
a. Determine a single error of the reference input vectors;
b. Temporarily store the reference input vector with the smallest single error and remove this reference input vector from the reference input vectors;
c. Calculate the output vector with the new reference input vector as the input vector;
d. Determining the single error from a difference between the output vector and the reference output vector assigned to the new reference input vector;
e. Add the removed reference input vector to the reference input vectors;
f. Replace the reference input vector with the smallest single error with the new reference input vector if the single error of the new reference input vector is greater than the smallest single error.

The control device preferably corresponds to the previously mentioned control device. The n-dimensional reference input vectors and the associated reference output vectors in turn define the characteristic map, the input vector is composed of the input variables and the output vector contains the second reducing agent mass flow. Preferably, the adaptation of the characteristic map is carried out in accordance with patent claim 1 of disclosure document DE 10 2020 111 206 A1. The method can be further developed in accordance with one or more of the patent claims 2 to 10 of the disclosure document DE 10 2020 111 206 A1. Additional advantageous embodiments are contained in the description of the disclosure DE 10 2020 111 206 A1 and can optionally be used in addition to the embodiment of the method described. The content of the disclosure DE 10 2020 111 206 A1 is hereby fully incorporated by reference into the present description.

The procedure described is used to improve the characteristic map directly during operation of the motor vehicle; it is therefore not necessary to temporarily store values or optimize the map in post-processing after the operation. Instead, the computing power of the control device is sufficient to determine the second reducing agent mass flow rate and to adapt the characteristic map.

An embodiment of the invention provides that one of the following operating modes is used:
a. a first operating mode, if at least one of the nitrogen oxide values is outside a predetermined value range and/or a number of values temporarily stored in a buffer memory for at least one of the nitrogen oxide values is less than a predetermined minimum number;
b. a second operating mode if 1) the second nitrogen oxide value corresponds within a tolerance range to the model nitrogen oxide concentration and the first nitrogen oxide concentration is greater than the second nitrogen oxide concentration, and/or 2) the second nitrogen oxide value is less than a threshold value, and/or thirdly the nitrogen oxide value is greater than the threshold value and is transient and the distance of the correlation coefficient determined from the nitrogen oxide values from the setpoint value, in particular taking into account a hysteresis, is less than a correlation threshold value; and/or
c. a third operating mode if 1) the first nitrogen oxide value is transient and the distance of the correlation coefficient determined from the nitrogen oxide values from the setpoint value is smaller than the correlation threshold value, in particular taking the hysteresis into account, and/or 2) the second nitrogen oxide concentration determined from the second nitrogen oxide value is greater than the first nitrogen oxide concentration determined from the first nitrogen oxide value and the second nitrogen oxide concentration is greater than the model nitrogen oxide concentration calculated from the first nitrogen oxide value and the second nitrogen oxide value on the basis of the nitrogen oxide concentration model, and/or 3) the thrust mode of the drive device is present and the second nitrogen oxide concentration is greater than the first nitrogen oxide concentration;
d. a fourth operating mode if the first nitrogen oxide value is stationary.

The drive device is operated in one of the aforementioned operating modes, preferably always in exactly one of the aforementioned operating modes. The operating mode to be used is determined on the basis of the aforementioned conditions and is subsequently used to operate the drive device until the condition or conditions for another of the operating modes apply. Preferably, the fourth operating mode is a fallback operating mode, which is used if none of the aforementioned conditions for the operating modes apply. The respective operating mode is used to operate the drive device if at least one of the conditions mentioned for it applies. It is therefore not necessary for several or even all conditions for the respective operating mode to be fulfilled. However, it can of course also be provided that several of the conditions mentioned in each case must be fulfilled for the corresponding operating mode to be used.

The first operating mode is used if one of the nitrogen oxide values is outside the specified value range. This indicates a faulty measurement, which cannot be used to reliably assess the reducing agent slip. The value range is defined in such a way that the nitrogen oxide values occurring during intended operation of the drive device lie within the value range. In addition or alternatively, the first operating mode is used if a sufficient number of nitrogen oxide values are not stored in the buffer memory.

The buffer memory is used to temporarily store the nitrogen oxide values; in particular, there is a separate buffer memory for each of the nitrogen oxide values. The first nitrogen oxide values are therefore temporarily stored in a first buffer memory and the second nitrogen oxide values in a second buffer memory. The buffer memory is preferably available as a FIFO buffer memory, in which the last measured values of the respective measured value are stored. The buffer memory is used in particular for averaging the respective nitrogen oxide values and for filtering and/or frequency analysis. If there is not a sufficient number of values in the buffer memory, a meaningful evaluation of the first reducing agent slip model and/or the second reducing agent slip model is not possible.

The second operating mode is used if the second nitrogen oxide value is within the tolerance range of the model nitrogen oxide concentration and at the same time the first nitrogen oxide concentration is greater than the second nitrogen oxide concentration. In this case, it is assumed that the nitrogen oxide values are caused solely by the nitrogen oxide and that no reducing agent can be present downstream of the vehicle catalytic converter. Additionally or alternatively, the second operating mode is used if the second nitrogen oxide value is below the threshold value. The threshold value is selected in such a way that when the second nitrogen oxide value falls below the threshold value, there is certainly no reducing agent in the exhaust gas downstream of the vehicle catalytic converter.

Additionally or alternatively, the second operating mode is used if the first nitrogen oxide value is greater than the threshold value and is transient at the same time. In addition, the distance of the correlation coefficient from the setpoint value must be smaller than the correlation threshold value. Whether the first nitrogen oxide value is stationary or transient is preferably assessed on the basis of the buffer memory for the first nitrogen oxide value. If the values stored in the buffer memory for the first nitrogen oxide value deviate sufficiently significantly from an average of the values, it is assumed that the first nitrogen oxide value is sufficiently transient.

The third operating mode is used if one or more of the above conditions apply. In the third operating mode, the reducing agent slip can be detected particularly well with the aid of the reducing agent slip models.

The fourth operating mode is used if the first nitrogen oxide value is sufficiently stationary. In this case, no meaningful evaluation of the reducing agent slip is usually possible using the reducing agent slip models. The procedure described can significantly improve the accuracy of determining the reducing agent slip.

An embodiment of the invention provides that when using the first operating mode, the total slip indicator is continuously calculated with frozen nitrogen oxide values and the total slip indicator is frozen; and/or when using the second operating mode, the total slip indicator is set to the first value and held, and/or an adaptation of the nitrogen oxide concentration model is made based on a difference between the second nitrogen oxide value and the model nitrogen oxide concentration; and/or when using the third operating mode, the total slip indicator is determined from the first slip indicator and the second slip indicator using the current nitrogen oxide values; and/or when using the fourth operating mode, the determination of the total slip indicator is suspended until a minimum number of different values has been recorded for at least one of the nitrogen oxide values.

In the first operating mode, the current nitrogen oxide values, in particular the nitrogen oxide sensors, are not used to run the reducing agent slip models, but rather values that were present immediately before the first operating mode has been initiated. Accordingly, in the first operating mode, the total slip indicator is also frozen at the level used immediately before the first operating mode was initiated. As no meaningful statement about the actual total slip indicator is possible in the first operating mode, it is assumed that the value of the total slip indicator present before the first operating mode was initiated continues to apply.

In the second operating mode, it is assumed that no reducing agent slip can occur (“no-slip”). Accordingly, the total slip indicator is set to the first value and kept at this level. Additionally or alternatively, the nitrogen oxide concentration model is adapted or its accuracy is improved in the second operating mode. For this purpose, the difference between the second nitrogen oxide value and the model nitrogen oxide concentration is determined. A correction factor for the nitrogen oxide concentration model or the model nitrogen oxide concentration determined using the nitrogen oxide concentration model is then determined from the difference and subsequently used to determine the model nitrogen oxide concentration. In the second operating mode, it is assumed that there is no reducing agent slip, that is the second nitrogen oxide value is solely due to the nitrogen oxide. The difference or the correction factor is preferably filtered in order to avoid influencing the nitrogen oxide concentration model through measurement errors.

In the third operating mode, the procedure is as described. The two slip indicators are determined first and then the total slip indicator is determined from these.

In the fourth operating mode, the determination of the total slip indicator is suspended and consequently frozen at its value immediately before the fourth operating mode is initiated. This continues until it is recognized that the nitrogen oxide value is transient again, that is there are a sufficient number of different values for the respective nitrogen oxide value. The procedure described again serves to improve the quality of the total slip indicator.

An embodiment of the invention provides that an error signal is generated at a total slip indicator corresponding to the second value. The total slip indicator shows that reducing agent slip is present, that is reducing agent is passing through the vehicle catalytic converter. The error signal is generated accordingly. For example, when the error signal occurs, it is provided to indicate this to a driver of the motor vehicle, in particular visually and/or acoustically. In addition, it may be provided to adjust an operating parameter of the drive device in such a way that the reducer slip is reduced, for example by reducing a nominal power, a nominal torque or the like. This prevents an impermissibly high amount of reducing agent from entering the outer environment.

The invention also relates to a drive device, preferably for a motor vehicle, in particular for carrying out the method as described herein, wherein the drive device has an exhaust gas-generating drive unit and at least one vehicle catalytic converter configured as an SCR catalytic converter for aftertreatment of the exhaust gas, wherein a reducing agent is added to the exhaust gas at least temporarily upstream of the vehicle catalytic converter.

The drive device is provided and configured to determine, in particular by means of a first nitrogen oxide sensor, a first nitrogen oxide value describing the nitrogen oxide content of the exhaust gas upstream of the vehicle catalytic converter and, in particular by means of a second nitrogen oxide sensor, a second nitrogen oxide value describing the nitrogen oxide content of the exhaust gas downstream of the vehicle catalytic converter and, at least temporarily, to determine a first slip indicator using a first reducing agent slip model and a second slip indicator using a second reducing agent slip model on the basis of the nitrogen oxide values, wherein a total slip indicator is determined from the first slip indicator and the second slip indicator.

For this purpose, the total slip indicator is set to the second status for a certain first period of time when one of the slip indicators changes status from a first status corresponding to the absence of reducing agent slip to a second status corresponding to reducing agent slip and is reset to the first status when the other of the slip indicators has not changed status by the end of the first period of time, and/or if the status of one of the slip indicators changes from the second status to the first status while the other of the slip indicators persists, is set to the first value only after a certain second period of time has elapsed and if the other slip indicator changes status before the second period of time has elapsed.

The advantages of such a configuration of the drive device or such a procedure have already been pointed out. Both the drive device and the method for operating it can be further developed in accordance with the explanations in the context of this description, so that reference is made to them in this respect.

The features and combinations of features described in the description, in particular the features and combinations of features described in the following description of the figures and/or shown in the figures, can be used not only in the combination indicated in each case, but also in other combinations or on their own, without departing from the scope of the invention. Thus, embodiments which are not explicitly shown or explained in the description and/or the figures, but which emerge from the explained embodiments or can be derived from them, are also to be regarded as being covered by the invention.

### BRIEF DESCRIPTION OF THE FIGURE(S)

The invention is explained in more detail below with reference to the exemplary embodiments shown in the drawing, without limiting the invention. The only

FIG. 1 a schematic representation of a drive device, preferably for a motor vehicle.

### DETAILED DESCRIPTION

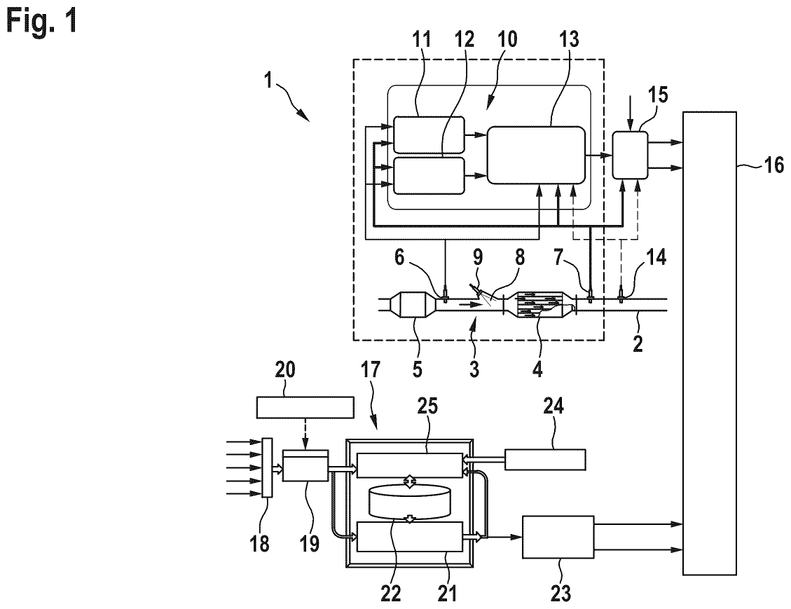

FIG. 1 shows a schematic representation of a drive device 1, preferably for a motor vehicle. The drive device 1 comprises a drive unit, not shown here, which generates exhaust gas during its operation, which is discharged via an exhaust line 2 in the direction of an outer environment of the drive device 1. An exhaust gas aftertreatment device 3 is present in the exhaust line 2, which in the exemplary embodiment shown here comprises at least one vehicle catalytic converter 4 configured as an SCR catalytic converter and an—optional—further vehicle catalytic converter 5.

A first nitrogen oxide sensor 6 is present upstream of the vehicle catalytic converter 4 and a second nitrogen oxide sensor 7 is present downstream of the vehicle catalytic converter 4. A first nitrogen oxide value describing the nitrogen oxide content of the exhaust gas upstream of the vehicle catalytic converter 4 is measured by means of the first nitrogen oxide sensor 6 and a second nitrogen oxide value describing the nitrogen oxide content of the exhaust gas downstream of the vehicle catalytic converter 4 is measured by means of a second nitrogen oxide sensor. The first nitrogen oxide sensor 6 can be omitted in an alternative embodiment. In this case, the first nitrogen oxide value is determined by means of a model.

For example, the first nitrogen oxide sensor 6 is arranged fluidically between the vehicle catalytic converter 4 and the further vehicle catalytic converter 5. Between the first nitrogen oxide sensor 6 and the vehicle catalytic converter 4, there is an introduction point 8 at which a reducing agent can be introduced into the exhaust gas by means of an injector 9, namely upstream of the vehicle catalytic converter 4.

The two nitrogen oxide values are fed to a first reducing agent slip model 10, which contains a frequency model 11 and a correlation model 12. Each of these models 11 and 12 is used to determine a partial indicator, namely a first partial indicator by means of the frequency model 11 and a second partial indicator by means of the correlation model 12. The two partial indicators are fed to a computing device 13, which combines them to form a first slip indicator. The computing device 13 preferably also performs a plausibility check of the first slip indicator using the first measured value, the second measured value and a nitrogen oxide value from a reducing agent sensor 14.

The first slip indicator is subsequently fed to a further computing device 15, as is at least one state variable, for example an exhaust gas temperature. In addition, the second nitrogen oxide value and/or the nitrogen oxide value of the reducing agent sensor 14 can be fed to the further computing device. At least from one of the nitrogen oxide values of the nitrogen oxide sensors 6 and 7 and the at least one state variable, the further calculation device 15 calculates a first reducing agent mass flow, namely using a reducing agent mass flow model. The further computing device 15 transmits both the first slip indicator and the first reducing agent mass flow to an evaluation device 16.

In addition, the drive device 1 has a second reducing agent slip model 17, to which several state variables are fed at an input 18, in particular the first nitrogen oxide value, an exhaust gas temperature, an exhaust gas temperature gradient, an exhaust gas mass flow and a difference between the second sensor value and a model nitrogen oxide concentration. The input variables 18 are filtered by means of a low-pass filter 19, at which certain filter parameters 20 are set. The low-pass filtered input variables are fed to a calculation unit 21, which determines a second reducing agent mass flow rate from the input variables using a characteristic map 22. This is transmitted to a calculation unit 23, which determines a second slip indicator from the second reducing agent mass flow. The second slip indicator and the second reducing agent mass flow are transmitted to the evaluation device 16.

If the reducing agent sensor 14 is present, the nitrogen oxide value detected by it is provided at an input 24. A calculation unit 25 uses the measured value of the reducing agent sensor 14 and the low-pass filtered input variable to adapt the characteristic map 22 so that the data stored in it is optimized.

The evaluation device 16 determines a total slip indicator from the first slip indicator and the second slip indicator and provides this at an output. For example, an error signal is generated if the total slip indicator corresponds to a certain value. The described configuration of the drive direction 1 or the explained method serves to determine the total slip indicator extremely precisely. Accordingly, it is determined with good accuracy whether reducing agent slip occurs through the vehicle catalytic converter 4 or not.

### LIST OF REFERENCE SIGNS

1 Drive device
2 Exhaust line
3 Exhaust gas aftertreatment device
4 Vehicle catalytic converter
Further vehicle catalytic converter
6 1. nitrogen oxide sensor
7 2. nitrogen oxide sensor
8 Introduction point
9 Injector
10 1. reducing agent slip model
11 Frequency model
12 Correlation model
13 Computing device
14 Reducing agent sensor
15 Further computing device
16 Evaluation device
17 2. reducing agent slip model
18 Input
19 Low-pass filter
20 Filter parameters
21 Calculation unit
22 Characteristic map
23 Calculation unit
24 Input
25 Calculation unit

1.-10. (canceled)

11. A method for operating a drive device which has an exhaust gas-generating drive unit and at least one vehicle catalytic converter configured as an SCR catalytic converter for aftertreatment of the exhaust gas, wherein a reducing agent is added to the exhaust gas at least temporarily upstream of the vehicle catalytic converter, wherein a first nitrogen oxide value describing the nitrogen oxide content of the exhaust gas upstream of the vehicle catalytic converter and a second nitrogen oxide value describing the nitrogen oxide content of the exhaust gas downstream of the vehicle catalytic converter are determined and at least temporarily a first slip indicator is determined using a first reducing agent slip model and a second slip indicator is determined using a second reducing agent slip model on the basis of the nitrogen oxide values, wherein a total slip indicator is determined from the first slip indicator and the second slip indicator, whereby the total slip indicator
a. is set to a second status for a certain first period of time when one of the slip indicators changes status from a first status corresponding to the absence of reducing agent slip to a second status corresponding to reducing agent slip, and is reset to the first status when the other of the slip indicators has not changed status by the end of the first period of time, and/or
b. when the status of one of the slip indicators changes from the second status to the first status and while the other of the slip indicators persists, is set to the first value only after a certain second period of time has elapsed and when the status of the other slip indicator changes before the second period of time has elapsed.

12. The method according to claim 11, wherein the first reducing agent slip model comprises a frequency model and/or a correlation model, wherein
a. a frequency model concentration value is determined for the frequency model by a frequency analysis of the nitrogen oxide values and a first partial indicator is set to the first value, when the frequency model concentration value falls below a first frequency model threshold value, and is set to the second value, when the frequency model concentration value exceeds a second frequency model threshold value, and/or wherein
b. a correlation coefficient is determined from the nitrogen oxide values for the correlation model, wherein a second partial indicator is set to the first value, when a distance of the correlation coefficient from a setpoint value, which corresponds to a match of the nitrogen oxide values, falls below a first correlation model threshold value, and is set to the second value, when the distance of the correlation coefficient from the setpoint value exceeds a second correlation model threshold value, and/or wherein
c. the first slip indicator is set to the second value, when the first partial indicator corresponds to the second value and/or the second partial indicator corresponds to the second value, and is set to the first value, when the first partial indicator corresponds to the first value and/or the second partial indicator corresponds to the first value.

13. The method according to claim 11, wherein the first slip indicator is set to the second value even when
a. a second nitrogen oxide concentration determined from the second nitrogen oxide value is greater than a first nitrogen oxide concentration determined from the first nitrogen oxide value and the second nitrogen oxide concentration is greater than a model nitrogen oxide concentration calculated from the first nitrogen oxide value and the second nitrogen oxide value on the basis of a nitrogen oxide concentration model, and/or when
b. the second nitrogen oxide concentration is greater than the first nitrogen oxide concentration during thrust operation of the drive device.

14. The method according to claim 11, wherein while the first slip indicator corresponds to the second value, a first reducing agent mass flow is determined from at least one of the nitrogen oxide values and at least one state variable of the drive device by a reducing agent mass flow model.

15. The method according to claim 11, wherein at least one of the nitrogen oxide values and at least one state variable of the drive device are used as input variables of a characteristic map in the second reducing agent slip model, from which a second reducing agent mass flow results as output variable, wherein the second slip indicator is set to the first value, when the second reducing agent mass flow falls below a first reducing agent slip model threshold value, and is set to the second value, when the second reducing agent mass flow exceeds a second reducing agent slip model threshold value.

16. The method according to claim 11, wherein a reducing agent concentration present downstream of the vehicle catalytic converter is measured by a reducing agent sensor and is used to adapt the characteristic map.

17. The method according claim 11, wherein one of the following operating modes is used:
a. a first operating mode, when at least one of the nitrogen oxide values is outside a predetermined value range and/or a number of values temporarily stored in a buffer memory for at least one of the nitrogen oxide values is less than a predetermined minimum number;
b. a second operating mode when
i. the second nitrogen oxide value corresponds within a tolerance range to the model nitrogen oxide concentration calculated from the first nitrogen oxide value and the second nitrogen oxide value on the basis of the nitrogen oxide concentration model, and the first nitrogen oxide concentration is greater than the second nitrogen oxide concentration, and/or
ii. the second nitrogen oxide value is less than a threshold value, and/or
iii, the first nitrogen oxide value is greater than the threshold value and is transient and the distance of the correlation coefficient determined from the nitrogen oxide values from the setpoint value is less than a correlation threshold value; and/or
c. a third operating mode, when
i. the first nitrogen oxide value is transient and the distance of the correlation coefficient determined from the nitrogen oxide values from the setpoint value is smaller than the correlation threshold value, and/or
ii. the second nitrogen oxide concentration determined from the second nitrogen oxide value is greater than the first nitrogen oxide concentration determined from the first nitrogen oxide value and the second nitrogen oxide concentration is greater than the model nitrogen oxide concentration calculated from the first nitrogen oxide value and the second nitrogen oxide value on the basis of the nitrogen oxide concentration model, and/or
iii, the thrust operation of the drive device is present and the second nitrogen oxide concentration is greater than the first nitrogen oxide concentration;
d. a fourth operating mode when the first nitrogen oxide value is stationary.

18. The method according to claim 11, wherein
a. when using the first operating mode, the total slip indicator is continuously calculated with frozen nitrogen oxide values and the total slip indicator is frozen; and/or
b. when using the second operating mode
i. the total slip indicator is set to the first value and held, and/or
ii. an adaptation of the nitrogen oxide concentration model is made on the basis of a difference between the second nitrogen oxide value and the model nitrogen oxide concentration; and/or
c. when using the third operating mode, the total slip indicator is determined from the first slip indicator and the second slip indicator using the current nitrogen oxide values; and/or
d. when using the fourth operating mode, the determination of the total slip indicator is suspended until a minimum number of different values has been recorded for at least one of the nitrogen oxide values.

19. The method according to claim 11, wherein an error signal is generated at a total slip indicator corresponding to the second value.

20. A drive device (for carrying out the method according to claim 11, wherein the drive device has an exhaust gas-generating drive unit and at least one vehicle catalytic converter configured as an SCR catalytic converter for aftertreatment of the exhaust gas, wherein a reducing agent is added to the exhaust gas at least temporarily upstream of the vehicle catalytic converter, wherein the drive device is provided and configured to determine a first nitrogen oxide value describing the nitrogen oxide content of the exhaust gas upstream of the vehicle catalytic converter and a second nitrogen oxide value describing the nitrogen oxide content of the exhaust gas downstream of the vehicle catalytic converter and determining, at least temporarily, a first slip indicator using a first reducing agent slip model and a second slip indicator using a second reducing agent slip model on the basis of the nitrogen oxide values, wherein a total slip indicator is determined from the first slip indicator and the second slip indicator, whereby the total slip indicator
a. is set to a second status for a certain first period of time when one of the slip indicators changes status from a first status corresponding to the absence of reducing agent slip to a second status corresponding to reducing agent slip, and is reset to the first status when the other of the slip indicators has not changed status by the end of the first period of time, and/or
b. when the status of one of the slip indicators changes from the second status to the first status and while the other of the slip indicators persists, is set to the first value only after a certain second period of time has elapsed and if the status of the other slip indicator changes before the second period of time has elapsed.

21. The method according to claim 12, wherein the first slip indicator is set to the second value even when
a. a second nitrogen oxide concentration determined from the second nitrogen oxide value is greater than a first nitrogen oxide concentration determined from the first nitrogen oxide value and the second nitrogen oxide concentration is greater than a model nitrogen oxide concentration calculated from the first nitrogen oxide value and the second nitrogen oxide value on the basis of a nitrogen oxide concentration model, and/or when
b. the second nitrogen oxide concentration is greater than the first nitrogen oxide concentration during thrust operation of the drive device.

22. The method according to claim 12, wherein while the first slip indicator corresponds to the second value, a first reducing agent mass flow is determined from at least one of the nitrogen oxide values and at least one state variable of the drive device by a reducing agent mass flow model.

23. The method according to claim 13, wherein while the first slip indicator corresponds to the second value, a first reducing agent mass flow is determined from at least one of the nitrogen oxide values and at least one state variable of the drive device by a reducing agent mass flow model.

24. The method according to claim 12, wherein at least one of the nitrogen oxide values and at least one state variable of the drive device are used as input variables of a characteristic map in the second reducing agent slip model, from which a second reducing agent mass flow results as output variable, wherein the second slip indicator is set to the first value, when the second reducing agent mass flow falls below a first reducing agent slip model threshold value, and is set to the second value, when the second reducing agent mass flow exceeds a second reducing agent slip model threshold value.

25. The method according to claim 13, wherein at least one of the nitrogen oxide values and at least one state variable of the drive device are used as input variables of a characteristic map in the second reducing agent slip model, from which a second reducing agent mass flow results as output variable, wherein the second slip indicator is set to the first value, when the second reducing agent mass flow falls below a first reducing agent slip model threshold value, and is set to the second value, when the second reducing agent mass flow exceeds a second reducing agent slip model threshold value.

26. The method according to claim 14, wherein at least one of the nitrogen oxide values and at least one state variable of the drive device are used as input variables of a characteristic map in the second reducing agent slip model, from which a second reducing agent mass flow results as output variable, wherein the second slip indicator is set to the first value, when the second reducing agent mass flow falls below a first reducing agent slip model threshold value, and is set to the second value, when the second reducing agent mass flow exceeds a second reducing agent slip model threshold value.

27. The method according to claim 12, wherein a reducing agent concentration present downstream of the vehicle catalytic converter is measured by a reducing agent sensor and is used to adapt the characteristic map.

28. The method according to claim 13, wherein a reducing agent concentration present downstream of the vehicle catalytic converter is measured by a reducing agent sensor and is used to adapt the characteristic map.

29. The method according to claim 14, wherein a reducing agent concentration present downstream of the vehicle catalytic converter is measured by a reducing agent sensor and is used to adapt the characteristic map.

30. The method according to claim 15, wherein a reducing agent concentration present downstream of the vehicle catalytic converter is measured by a reducing agent sensor and is used to adapt the characteristic map.
